(19) United States
(12) Patent Application Publication
(10) Pub. No.: US 2007/0022200 A1
(43) Pub. Date: Jan. 25, 2007

(54) Communication Session Server

(75) Inventors: Michael Benkert, Hohenassel (DE); Holger Schmidt, Braunschweig (DE); Norbert Schwagmann, Braunschweig (DE); Hyung-Nam Choi, Hamburg (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/458,572

(22) Filed: Jul. 19, 2006

(30) Foreign Application Priority Data
Jul. 19, 2005 (DE) 102005033667.1-31

(51) Int. Cl. G06F 15/16

(52) U.S. Cl. 709/227

(57) ABSTRACT

At least one received broadcast capability parameter from at least one communication terminal participating in a communication session is used to decide whether data within the context of the communication session are to be transmitted to the communication terminal using a broadcast communication network or using a cellular mobile radio communication network.

### CROSS-REFERENCE TO RELATED APPLICATION

This application claims priority to German Patent Application Serial No. 10 2005 033 667.1-31, which was filed on Jul. 19, 2005, and is incorporated herein by reference in its entirety.

### TECHNICAL FIELD OF THE INVENTION

The invention relates to a communication session server, a communication terminal, a network unit, a method for controlling a communication session with a plurality of communication terminals, a method for setting up a communication session and computer program elements.

The development of digital broadcast technology allows inexpensive distribution of broadband media services to mobile subscribers. This allows new business ideas to be developed for service providers and technology providers. Mobile broadcast technology will account for a not unsubstantial proportion of mobile services in the future. The provision and distribution of mobile broadcast services require a communication system which achieves a number of different objects. A full communication system comprises various parts, normally operated and managed by several different companies. Depending on the business idea and the current scenario for those involved, the function distributions and responsibilities among those involved in business may vary from time to time.

### BRIEF DESCRIPTION OF THE FIGURES

In the FIGS.

FIG. 1 shows a functional model for mobile broadcast services;

FIG. 2 shows a block diagram of a communication system based on an exemplary embodiment of the invention;

FIG. 3 shows a block diagram of a communication terminal based on an exemplary embodiment of the invention;

FIG. 4 shows a message flowchart showing a method of a first exemplary embodiment of the invention; and

FIG. 5 shows a message flowchart showing a method of a second exemplary embodiment of the invention.

### DETAILED DESCRIPTION

Exemplary embodiments of the invention are illustrated in the figures and are explained in more detail below. In the figures, elements which are the same or identical have been provided with identical reference symbols where expedient.

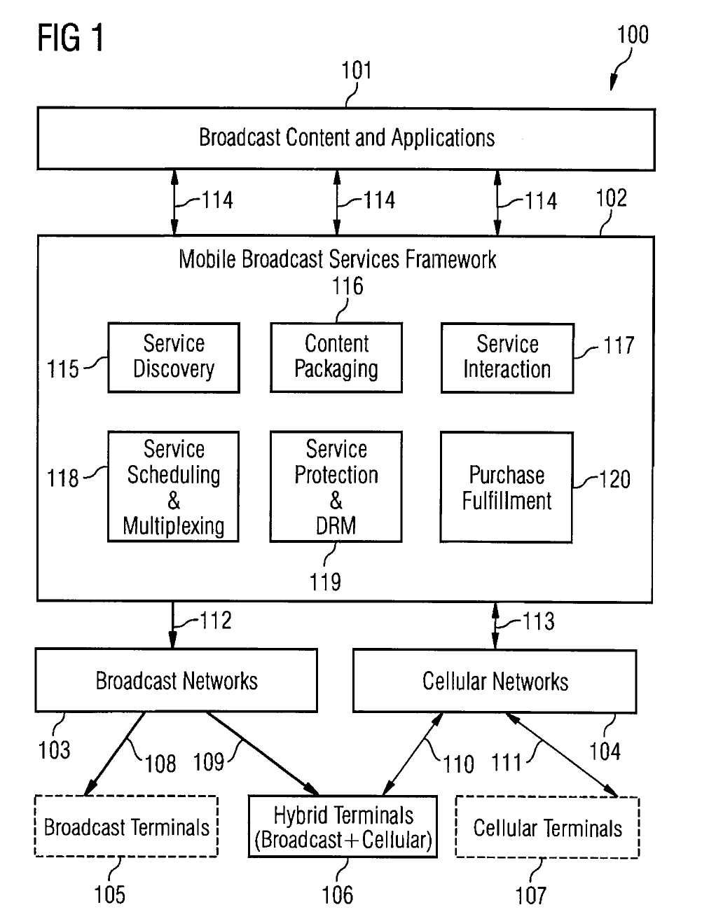

FIG. 1 shows a sketch 100 of a functional model for mobile broadcast services. The functional model has broadcast contents and broadcast applications (Block 101) and also a framework for mobile broadcast services, also called the Mobile Broadcast Services Framework (Block 102 in FIG. 1), and also at least one broadcast communication network 103 and at least one cellular communication network 104. In addition, the relevant communication terminals, particularly broadcast communication terminals 105, hybrid communication terminals, i.e. communication terminals 106 which are set up both to receive information using a broadcast communication network and to receive information using a cellular communication network, and cellular communication terminals 107 are provided.

In addition, FIG. 1 shows the relevant air interfaces 108, 109, 110, 111 between the networks and the communication terminals 105, 106, 107, with a first air interface 108 being shown which represents a unidirectional air communication link between a broadcast communication terminal 105 and the broadcast communication network 103. A second air interface 109 is shown, which represents a unidirectional air communication link between the broadcast communication network 103 and the hybrid communication terminal 106. In addition, a third air interface is shown which represents a bidirectional air communication link between the cellular communication network 104 and the hybrid communication terminal 106. A fourth air interface 111 represents a bidirectional radio communication link between the cellular communication network 104 and the cellular communication terminal 107.

The first air interface 108 and the second air interface 109 are air interfaces, which are set up for unidirectional radio data transmission from the broadcast communication network 103 to the respective communication terminal 105, 106. The third air interface 110 and the fourth air interface 111 are set up as bidirectional radio communication links between the communication terminals 106, 107 and the cellular communication network 104. In addition, the functional model 100 shows a first network interface 112 between the Mobile Broadcast Services Framework 102 and the broadcast communication network 103 and also a second network interface 113, which is provided between the Mobile Broadcast Services Framework 102 and the cellular communication network 104.

In addition, interfaces 114 are provided between the individual components of the Mobile Broadcast Services Framework 102 and the broadcast contents and broadcast applications 101.

The Mobile Broadcast Services Framework 102 currently has the following components, without restricting general validity:
a Service Discovery component 115,
a Content Packaging component 116,
a Service Interaction component 117,
a Service Scheduling and Multiplexing component 118,
a Service Protection and Digital Rights Management (DRM) component 119,
a Purchase Fulfillment component 120.

The components 115 to 120 providing the respective functionalities also have interfaces with one another, which is not shown in FIG. 1.

The standardization committee Open Mobile Alliance (OMA) is currently working on standardizing mobile broadcast services. This is done in the subworking group BCAST, in particular. This group is particularly working on standardizing the mobile broadcast services of the Mobile Broadcast Services Framework 102 and the associated interfaces 112, 113, 114.

Mobile broadcast services are used to provide a link to existing standardized services such as communication services (for example Push-to-Talk over Cellular (PoC) or Conferencing). These services are session-based and group-oriented, i.e. a group of several subscribers gets together to use this service temporarily, that is to say for a prescribable period of time, in comparable fashion to a conference or session.

Broadcast communication networks are used for unidirectional broadband circulation of services, applications or simply just contents among a large number of subscribers. Examples of typical digital broadcast systems are DVB-T (Digital Video Broadcasting-Terrestrial), DVB-H (Digital Video Broadcasting-Handheld), MBMS (Multimedia Broadcast/Multicast Services), ISDB-T (Integrated Services Digital Broadcasting for Terrestrial), BCMCS (Broadcast/Multicast Services), etc.

A cellular communication network, on the other hand, is used for a large number of important and crucial functions within broadcast services. These key functions comprise subscriber authentication, position-finding for the subscriber, charge metering, content acquisition and billing options, for example. Connectivity on the communication network is a fundamental requirement for interactive broadcast services. This does not apply to noninteractive one way broadcast services.

A usual principle with session-based services is that a subscriber sets up a session with one or more other subscribers. Following session setup by means of an appropriate communication protocol, for example by means of the Session Initiation Protocol (SIP) and the Session Description Protocol (SDP) using the IP-based Multimedia Subsystem (IMS) the media streams (media data streams) are transported between the subscribers by means of the “Realtime Transport Protocol” (RTP) using the Realtime Transport Control Protocol (RTCP). The IP-based Multimedia Subsystem is a part of the mobile communication network, in other words the mobile radio network, which allows SIP-based session control and service control (for example routing, authentication, authorization, . . . ) but itself does not transport media data streams. Within the context of mobile radio, session-based services are used/circulated only in a cellular mobile radio communication network such as a cellular mobile radio communication network based on GPRS (General Packet Radio Service), UMTS (Universal Mobile Telecommunications System) etc. since these allow bidirectional communication. This is of particular significance to session setup and control of the media data stream.

To be able to use a higher data rate and hence an increased bandwidth for transmitting data, for example, particularly within the context of a session-based service such as Push-to-Talk over Cellular (PoC) or Conferencing, it is desirable to use a broadcast technology, such as DVB-H, DVB-T, etc. within this context in order to transport the voice data to the subscribers within the context of the session-based service.

In line with one exemplary embodiment of the invention, session-based services for a plurality of subscribers in a communication session and a broadcast technology are integrated together inexpensively.

The embodiments of the invention which are described below relate, where appropriate, to the communication session server, the communication terminal, the network unit, the method for controlling a communication session with a plurality of communication terminals and the relevant computer program elements.

One exemplary embodiment of the invention provides a communication session server, having a communication session setup unit which sets up a communication session with a plurality of communication terminals, a communication session control unit which controls the communication session which has been set up, a receiver which receives at least one broadcast capability parameter from at least one communication terminal participating in the communication session, the at least one broadcast capability parameter specifying whether the communication terminal can receive data using a broadcast communication network, a decision maker which decides whether data within the context of the communication session are to be transmitted to the communication terminal using a broadcast communication network, and a broadcast request message generation unit which generates a broadcast request message for broadcast server to transmit data within the context of the communication session to the at least one communication terminal using a broadcast communication network.

In one embodiment of the invention, a communication session server has a communication session setup unit which sets up a communication session with a plurality of communication terminals. In addition, a communication session control unit is provided which controls the communication session which has been set up. The communication session server also has a receiver which receives at least one broadcast capability parameter from at least one communication terminal participating in the communication session. The at least one broadcast capability parameter specifies whether the communication terminal can receive data using a broadcast communication network. In addition, a decision maker is provided which decides whether data within the context of the communication session are to be transmitted to the communication terminal using a broadcast communication network, and optionally whether the data within the context of the communication session are to be transmitted via a communication link for the communication session which has been set up, for example by means of a bidirectional communication network which was used to set up the communication session. In addition, a broadcast request message generation unit is provided which generates a broadcast request message for a broadcast server unit, the broadcast request message being used to ask the broadcast server unit to transmit data within the context of the communication session to the at least one communication terminal using a broadcast communication network.

Within the context of this description, a broadcast server is to be understood to mean a server (or a server unit), for example, which the broadcast server operator has and manages.

A communication terminal has a communication session client which implements a communication session with at least one other communication terminal using a communication session server. In addition, a message generation unit is provided which generates at least one broadcast capability message, with the message generation unit adding at least one broadcast capability parameter to the broadcast capability message, specifying whether the communication terminal can receive data using a broadcast communication network.

In line with one exemplary embodiment of the invention, a broadcast server is provided which has a receiver which receives at least one broadcast request message from a communication session server which the communication session server uses to request that data be transmitted within the context of a communication session controlled by the communication session server to at least one communication terminal using a broadcast communication network.

In addition, a transmitter is provided sending data within the context of the communication session using the broadcast communication network in line with the received broadcast request message.

A network unit has a receiver which receives at least one broadcast capability parameter from at least one communication terminal, the at least one broadcast capability parameter being used to specify whether the communication terminal can receive data using a broadcast communication network. In addition, the network unit has a memory which receives the at least one received broadcast capability parameter and a transmitter which sends the at least one broadcast capability parameter to a communication session server.

In a method of controlling a communication session with a plurality of communication terminals based on an exemplary embodiment of the invention, at least one received broadcast capability parameter from at least one communication terminal participating in the communication session is used to decide whether or not data within the context of the communication session are to be transmitted to the communication terminal using a broadcast communication network. The at least one broadcast capability parameter specifies whether the communication terminal can receive data using a broadcast communication network. If data within the context of the communication session are to be transmitted to the communication terminal using a broadcast communication network, then a broadcast request message is generated for a broadcast server and is used to request that data be transmitted within the context of the communication session at least to one communication terminal using a broadcast communication network.

In line with another exemplary embodiment of the invention, a method of setting up a communication session is provided in which a communication session client for a communication terminal sets up a communication session with at least one other communication terminal using a communication session server. At least one broadcast capability parameter specifying whether the communication terminal can receive data using a broadcast communication network is sent to the communication session server.

In line with another exemplary embodiment of the invention, a method of transmitting data within the context of a communication session using a broadcast server is provided in which at least one broadcast request message is received from a communication session server which the communication session server uses to request that data be transmitted within the context of a communication session controlled by the communication session server to the at least one communication terminal using a broadcast communication network. Within the context of the communication session, data are sent using the broadcast communication network in line with the received broadcast request message.

In addition, in line with one exemplary embodiment of the invention, computer program elements are provided which, when a respective computer program element is executed by a processor, carry out a respective method as described above of controlling a communication session with a plurality of communication terminals, for setting up a communication session and for transmitting data within the context of a communication session using a broadcast server having the features described above.

In this connection, it should be noted that the methods described above can be implemented by means of software, i.e. by means of a computer program, alternatively by means of hardware, i.e. by means of a specifically matching electronic circuit, or in hybrid form, i.e. in any split containing software and hardware components.

In one exemplary embodiment of the invention, the at least one broadcast capability parameter is used to describe the capabilities of the communication terminal in terms of receiving and/or processing data transmitted using a broadcast communication network.

One embodiment clearly opens up a very simple possibility for changing over, within the context of a communication session between a plurality of communication terminals, between a (usually bidirectional) communication link which is used within the context of the communication session for communication between the communication terminals and the use of a (usually unidirectional) broadcast communication network in order to transmit data to a communication terminal or to a plurality of communication terminals. In this connection, it should be noted that in line with one embodiment of the invention the useful data transmission is carried out unidirectionally, where appropriate using a broadcast network and the signaling remains bidirectional, for example using the mobile radio network.

Embodiments of the invention form the basis particularly for a higher level of flexibility for SIP-based services and allow resources to be stored in a cellular communication network and transmission of the services using broadcast technology in better quality and at a higher data rate if appropriate.

Within the context of this description, a broadcast communication network is to be understood, by way of example, to mean a network which sends data unidirectionally, for example in broadband format, without addressing specific receivers; examples of a broadcast communication network of this kind are networks based on DVB-T (Digital Video Broadcasting-Terrestrial), DVB-H (Digital Video Broadcasting-Handheld), MBMS (Multimedia Broadcast/Multicast Services), ISDB-T (Integrated Services Digital Broadcasting for Terrestrial), BCMCS (Broadcast/Multicast Services).

The network for transmitting the communication session data which is provided as standard within the context of the communication session is usually a bidirectional communication network, i.e. a communication network which allows bidirectional communication between the subscribers, to be more precise between the communication terminals belonging to the subscribers. A communication network of this kind may be a communication network based on the Internet, for example, i.e. based on the communication protocols Internet Protocol (IP)/Transport Control Protocol (TCP). Alternatively, the communication network may be a cellular communication network, for example a cellular mobile radio communication network which is designed in line with GSM (Global System for Mobile Communications), GPRS (General Packet Radio Service), UMTS (Universal Mobile Telecommunications System), CDMA 2000 (Code Division Multiple Access 2000), for example.

In one exemplary embodiment of the invention, within the context of a communication session in a communication network with bidirectional communication links between the communication terminals, a communication session server clearly checks whether it is appropriate to transmit data within the context of the communication session to one or more of the participating communication terminals using a broadcast communication network at, particularly in this case, a usually increased available data rate.

This provides a very simple way of integrating session-based services for groups of subscribers, for example for the Push-to-Talk service, for example Push-to-Talk over Cellular (PoC), conferencing, for example Internet-based conferencing (for example in line with the IETF Conferencing Framework), into the “broadcast world”, in other words into the broadcast technologies and hence into the broadcast communication networks, without any great alterations to the communication standard and in this way saving scarce resources, for example a scarce available bandwidth, as are usually available in a cellular communication network such as GSM, GPRS or UMTS, and allowing more flexibility for these services.

Media streams can also be transmitted in better quality and at a higher data rate using broadcast technology, which is frequently not possible using a communication network in a cellular communication system.

The communication session server may have a checking unit which checks whether the communication terminal can receive data using a broadcast communication network in line with the at least one received broadcast capability parameter. In this case, the decision maker decides to transmit the data within the context of the communication session using the broadcast communication network only if the communication terminal can receive data using a broadcast communication network in line with the checking result from the checking unit, for example.

In this case, it is ensured that first of all a check is performed to determine whether the respective communication terminal is actually capable of receiving and processing the data transmitted by the broadcast communication network within the context of the communication session and that a broadcast request message is not formed for and transmitted to the broadcast server until the respective communication terminal can also process these data as appropriate.

In line with one embodiment of the invention, the communication session setup unit communicates on the basis of a communication session setup protocol, for example on the basis of the Session Initiation Protocol (SIP).

In line with one embodiment of the invention, the broadcast request message generation unit generates the broadcast request message on the basis of a communication session setup protocol, for example on the basis of the Session Initiation Protocol (SIP).

In addition, the communication session server may provide a half-duplex communication session, for example a Push-to-Talk-communication session, for example a Push-to-Talk over Cellular communication session. Alternatively, the communication session server may provide an Internet-based communication session, for example a communication session based on the IETF Conferencing Framework.

A half-duplex communication session is to be understood to mean a communication session in which the participating communication terminals are each explicitly allocated (in other words granted) a communication right, for example a talk right, or alternatively a right to transmit multimedia data, for example video data, audio data, still-picture data, text data, etc., so that in each case just one subscriber, if appropriate additionally possibly one or more other subscribers, for example additionally the moderator of the communication session, if present, is allocated the communication right and the other participating communication terminals act merely as receivers of the data introduced by the communication terminal which has been provided with the communication right.

In one embodiment of the communication terminal, the communication session client communicates on the basis of the Session Initiation Protocol (SIP).

In line with another embodiment of the invention, the communication terminal provides a half-duplex communication session, for example a Push-to-Talk communication session, for example a Push-to-Talk over Cellular communication session. Alternatively, the communication terminal may provide an Internet-based communication session.

In line with one embodiment of the broadcast server, it additionally has a communication session client which implements a communication session with the communication session server, the communication session client being able to communicate on the basis of the Session Initiation Protocol (SIP).

In line with another embodiment of the invention, the broadcast server has a message generation unit which generates at least one SIP-Transport parameter message for the at least one communication terminal participating in the communication session which (terminal) is intended to have the data transmitted to it within the context of the communication session using a broadcast communication network, with the message generation unit adding the transport parameters used to the SIP-Transport parameter message when the data are transmitted via the broadcast communication network.

In this way, the broadcast server clearly transmits the transport parameters which it uses within the context of transmitting the data via the broadcast communication network, for example the frequency used, the time slots used, etc., to the respective designated receiver communication terminals. These data can be transmitted on the basis of the communication session setup protocol used, in other words the message generation unit in this case generates the SIP-Transport parameter message on the basis of the communication session setup protocol, for example on the basis of the Session Initiation Protocol (SIP).

In line with this embodiment of the invention, the protocols used within the context of communication session setup are easily used to allow the transport parameters used within the context of broadcast data transmission to be transmitted to the respective receiver communication terminals. In this case, it is not necessary to use a different protocol and hence to alter the embodiment of the broadcast server further, since in this case the message generation unit can be set up in the same way as the communication session client, in other words in this case the message generation unit can use the communication session client, or can be identical to it.

In line with another embodiment of the invention, a broadcast checking unit is provided in the broadcast server, the broadcast checking unit checking whether the requested transmission of the data within the context of the communication session is possible using a broadcast communication network. In addition, a broadcast decision maker is provided which decides, using the checking result from the broadcast checking unit, whether the requested transmission of the data within the context of the communication session is carried out using a broadcast communication network.

Clearly, the effect achieved in line with this embodiment of the invention is that the requested broadcast transmission is accepted and carried out by the broadcast server only if it has appropriate resources available within the broadcast communication network. If this is not the case, then the request which has been sent by the communication session server is rejected, which can be communicated to the latter by virtue of the broadcast server transmitting an appropriate rejection message.

In this case, the data continue to be transmitted within the context of the communication session using the usually bidirectional communication network.

In line with another embodiment of the invention, the network unit contains a communication session client for implementing a communication session with the communication session server, the communication session client being able to communicate on the basis of a communication session setup protocol, for example on the basis of the Session Initiation Protocol (SIP).

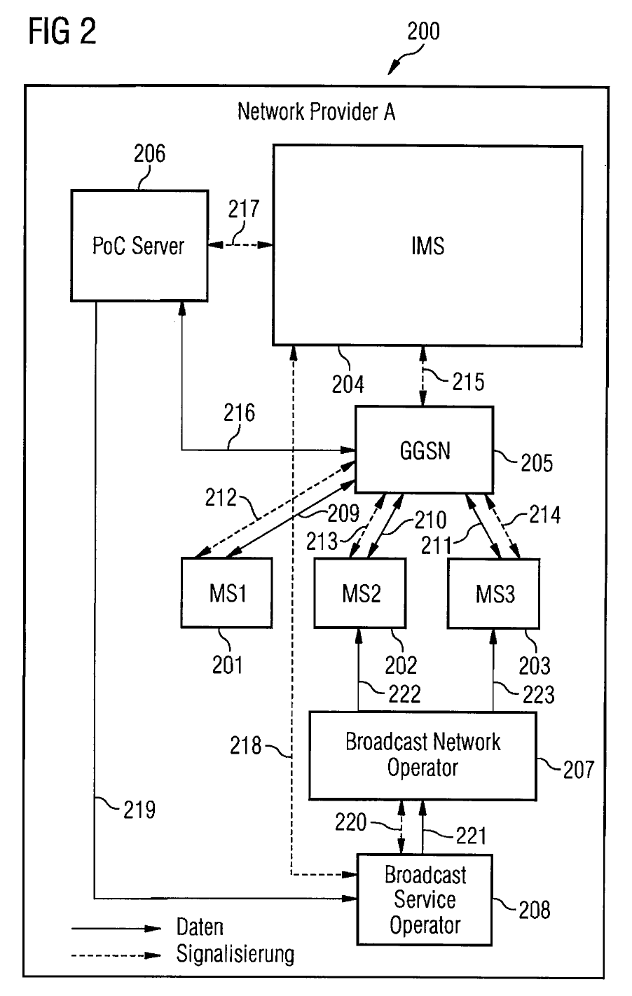

FIG. 2 shows a block diagram of a communication system 200 based on the exemplary embodiments of the invention.

In line with all exemplary embodiments of the invention, the architecture of the communication system 200 is in a form which is identical and as illustrated in FIG. 2 and described below, but with the individual units being of different design depending on the intended variant within the context of message interchange, so that the respective method processes can be implemented.

The text below describes methods of distributing media data streams for a Session Initiation Protocol (SIP) session using broadcast technology.

The exemplary embodiments described below contain processes, with mobile communication terminals, for example mobile radio communication terminals having reception devices of receiving data from one or more cellular mobile radio networks and of receiving data from one or more broadcast communication networks, being assumed without restricting the general validity.

In line with one embodiment of the invention, provision is made for broadcast capabilities of an SIP session client to be signaled to the SIP session server. The signaling indicates to the SIP session server, as communication session server, what routes can be used to transport the media data streams (media streams) to the client, for example to the communication terminal. The way this can be implemented in detail is described more explicitly below.

Basically, the following possibilities should be pointed out:
direct signaling of the broadcast capabilities as broadcast capability parameters from the SIP session client to the SIP session server, for example using the Session Description Protocol (SDP);
broadcast capabilities of an SIP session client are managed centrally in a suitable network element, subsequently also called the Network Info Node. An SIP session server can then check the broadcast capabilities of an SIP session client with it at any time. In this context, the broadcast capabilities in the form of broadcast capability parameters can be kept up to date in this network element in various ways:
   a) the mobile broadcast network(s) is/are continuously measured by the communication terminal, for example of the user equipment based on UMTS, and the measured parameters are signaled to the network unit, in other words to the network element;
   b) Routing Area Updates (the information regarding where the mobile radio communication terminal is situated is updated) are used to notify the central network element of where the mobile radio communication terminal (also called the mobile station) is situated. A new service is able to tell from the position whether a broadcast service is actually available at the location.

In line with another embodiment of the invention, the SIP session server and the decision maker provided therein can make a decision regarding whether the data within the context of the communication session are to be transmitted using a broadcast communication network, on the basis of prescribable criteria, and hence by what route the media data streams are to be transported.

Examples of possible criteria to be taken into account within the context of prescribable decision logic are:
Availability using access technology, in other words a check is performed to determine whether the subscriber, i.e. the subscriber's communication terminal, is actually available via his desired broadcast communication network;
Costs, in other words a check is performed to determine what the cost would be for transmitting using a broadcast communication network in comparison with transmitting the data using a cellular mobile radio network, generally using the bidirectional communication network used within the context of the communication session;
Number of subscribers to an access technology, i.e. a check is performed, by way of example, to determine how many subscribers, to be more precise how many communication terminals belonging to subscribers in the communication session, are available in what manner;
Presence using access technology, in other words a check is performed to determine whether the broadcast communication network is actually available;
User Preferences, i.e. it is considered or a check is performed to determine whether a user always wishes to receive his data via a broadcast communication network, for example;
Billing, i.e. a check is performed, by way of example, to determine whether it is actually possible to bill for the content which is to be transmitted, this possibly being precluded on account of contractual regulations, for example;
Charge metering;
etc.

In line with another embodiment of the invention, provision is made for the necessary network parameters, which are obtained from the decision made by checking the prescribable criteria described above, for transporting the media data streams from the SIP session server to the SIP session clients to be signaled using the Session Description Protocol (SDP). To be able to signal broadcast-specific network parameters in this case too, the SDP is extended by additional parameters, as is explained in more detail below. Data are received and transported on different network interfaces in line with the prescribed configuration.

Without restricting the general validity, the hybrid communication system 200 shown in FIG. 2 has three mobile stations, i.e. in other words three mobile radio communication terminals 201, 202, 203, with a first mobile radio communication terminal 201 being a mobile radio communication terminal which is set up to communicate on the basis of the GPRS communication standard or on the basis of the UMTS communication standard and hence is equipped with an access to a mobile radio communication network based on GPRS or based on UMTS. The second mobile radio communication terminal 202 and the third mobile radio communication terminal 203 are likewise set up to communicate on the basis of the GPRS communication standard or on the basis of the UMTS communication standard and hence likewise have access to a mobile radio communication network using GPRS or using UMTS. In addition, the second mobile radio communication terminal 202 and the third mobile radio communication terminal 203 are additionally set up to receive and/or to process data on the basis of a standard for a broadcast communication network (or a plurality of broadcast communication networks), in line with this exemplary embodiment to receive and/or to process data in line with a digital video broadcast communication network, for example on the basis of the DVB-H standard or on the basis of the DVB-T standard. The relevant broadcast communication network therefore has an opportunity to connect to the second mobile radio communication terminal 202 and to the third mobile radio communication terminal 203. The broadcast communication network and also the associated broadcast components, for example the Broadcast Communication Network

Operator unit, may be set up to send (broadcast) and/or process data on the basis of another of the broadcast communication standards described above, or alternatively on the basis of any other broadcast communication standard.

In addition, the communication system 200 has an IP-based Multimedia Subsystem (IMS) 204 and also a Gateway GPRS Support Node (GGSN) 205. In addition, a Push-to-Talk over Cellular-server (PoC server) 206 is provided. An additional element in the communication system 200 is a Broadcast Communication Network Operator unit 207 and also a Broadcast Service Operator unit 208, which are in a form based on the Mobile Broadcast Services Framework. In other words, this means that the broadcast communication network operator has implemented an appropriate communication framework, the Broadcast Communication Network Operator unit 207 normally not having implemented the communication framework.

FIG. 2 uses solid arrows to show respectively directed useful data communication links, and also uses arrows shown by dashes to show respectively directed signaling communication links between the individual units.

Hence, as FIG. 2 shows, each mobile radio communication terminal 201, 202, 203 has a respective useful data communication link 209, 210, 211 and additionally a signaling communication link 212, 213 or 214 to the GGSN 205. The useful data communication links 209, 210, 211 and the signaling communication links 212, 213, 214 between the mobile radio communication terminals 201, 202, 203 and the GGSN 205 are bidirectional communication links, that is to say that there can be a flow of data in both communication directions. A further bidirectional communication link is provided as a signaling communication link 215 between the GGSN 205 and the IMS 204. A bidirectional useful data communication link 216 is provided between the PoC server 206 and the GGSN 205. In addition, a bidirectional signaling communication link 217 is provided between the PoC server 206 and the IMS 204. The signaling communication link 217 uses the IMS for signaling.

In addition, there is a signaling communication link 218 between the IMS 204 and the Broadcast Service Operator unit 208. A unidirectional communication link for communication from the PoC server 206, directed toward the Broadcast Service Operator unit 208 is symbolized by arrow 219 in FIG. 2. In addition, the Broadcast Service Operator unit 208 and the Broadcast Network Operator unit 207 are connected to one another on the basis of a further bidirectional signaling communication link 220, and the Broadcast Service Operator unit 208 can transmit useful data to the Broadcast Network Operator unit 207 using an appropriate unidirectional useful data communication link 221.

The Broadcast Network Operator unit 207 has corresponding unidirectional, but in line with this embodiment of the invention not dedicated, communication links 222, 223 to the second mobile radio communication terminal 202 and to the third mobile radio communication terminal 203.

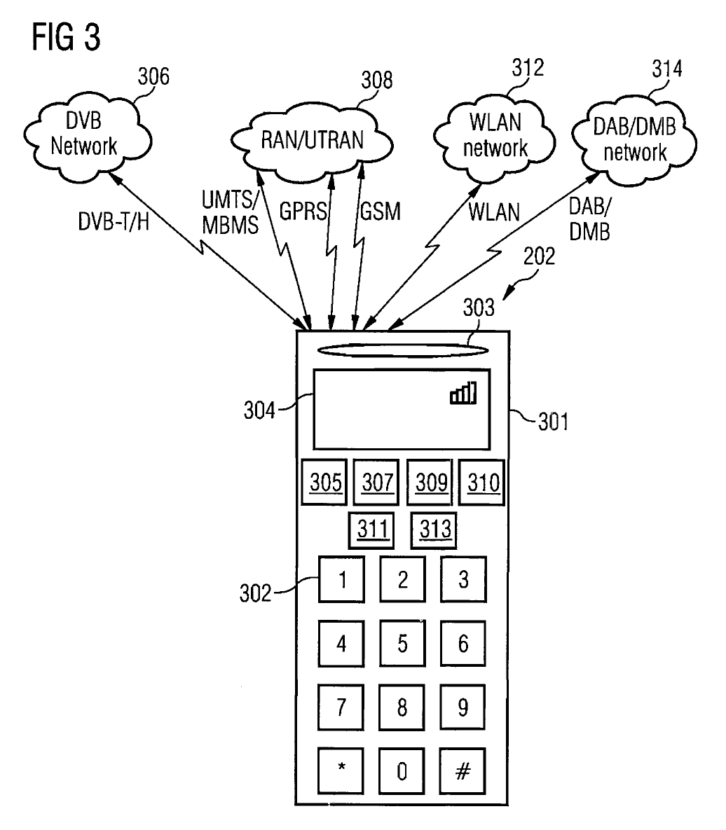

FIG. 3 schematically shows the second mobile radio communication terminal 202 in a block diagram. The third mobile radio communication terminal 203 is designed in the same way.

The second mobile radio communication terminal 202 has at least one, for example aplurality of, antenna(s) (not shown) and also a housing 301 with keys 302 for controlling the mobile radio communication terminal 202, for example for inputting a telephone number or for inputting other commands used within the context of a communication link.

The second mobile radio communication terminal 202 also has a microphone (not shown) for picking up voice signals from a user of the communication terminal 202 and also a loud speaker 303 for outputting audio information, for example voice signals, to the user. In addition, a screen display unit 304 is provided for showing visual information to the user.

FIG. 3 also schematically shows that the second mobile radio communication terminal 202 has different units for providing a respective communication link on the basis of different communication standards.

Thus, a first communication unit 305 is provided which is set up such that it allows a communication link and reception and hence decoding of received data on the basis of a digital video broadcast standard, for example a DVB-T standard or a DVB-H standard, and hence a communication link to a DVB network 306.

In addition, a second communication unit 307 is provided which is set up for communication on the basis of the UMTS communication standard and/or on the basis of the MBMS communication standard, which allows a communication link to a radio access network 308, for example to a UTRAN (UMTS Terrestrial Radio Access Network) in the case of UMTS.

A likewise provided third communication unit 309 is used to allow communication on the basis of the GPRS communication standard and hence likewise an air communication interface to a radio access network 308.

A fourth communication unit 310 is used to provide communication on the basis of the GSM communication standard and hence likewise an air communication link to the radio access network 308 and hence to a mobile radio core network (not shown).

In addition, a fifth communication unit 311 is provided which provides communication on the basis of a WLAN (Wireless Local Area Network) communication standard, for example on the basis of HIPERLAN, or IEEE 802.11 communication standard and hence an air communication interface to a corresponding WLAN network 312 of this type.

In addition, a sixth communication unit 313 is provided which allows unidirectional communication on the basis of a DAB communication standard or a DMB communication standard and hence for receiving signals from a DAB/DMB network 314.

The units described above are respectively set up such that the relevant data to be coded and decoded can be coded and decoded on the basis of the respective communication standard. For unidirectional communication, that is to say for unidirectional reception of data from the broadcast networks 306, 314, the relevant communication units 305, 313 are provided merely with a receiver and with a decoder for decoding the received data.

It should be pointed out that in alternative embodiments the units described above can be provided in any combination with one another and additional communication units can be provided for communication from other communication standards, for example for communication on the basis of CDMA 2000, etc.

In one alternative embodiment, one or more of the communication units may also not be provided.

It is merely desirable that the second mobile radio communication terminal 202 and the third mobile radio communication terminal 203 respectively be set up as hybrid communication terminals, that is to say as mobile radio communication terminals, that is to say for communication on the basis of a cellular mobile radio communication standard and additionally for the purpose of receiving and decoding signals which have been transmitted using a broadcast communication network.

In line with this exemplary embodiment of the invention, the first mobile radio communication terminal 201 is merely set up to communicate on the basis of one or more of the aforementioned cellular mobile radio communication standards, such as UMTS/MBMS, GPRS, GSM, CDMA 2000, etc.

In the example which follows, it is assumed that the first mobile radio communication terminal 201 sets up a communication session with the other two mobile radio communication terminals 202, 203. Media data streams are transmitted between the mobile radio communication terminals 201, 202, 203, and the first mobile radio communication terminal 201 clears down the communication session again. As described above, the first mobile radio communication terminal 201 has just one communication link to a cellular mobile radio communication network.

The second mobile radio communication terminal 202 and the third mobile radio communication terminal 203 have a respective communication link to a cellular mobile radio communication network and also to a broadcast communication network. In other words, this means that they have integrated at least two mutually independent network interfaces for mobile communication terminals 202, 203.

In line with the embodiments of the invention which follow, the messages described which are interchanged between the individual units are encoded using the IMS for transporting the messages on the basis of the Session Initiation Protocol (SIP).

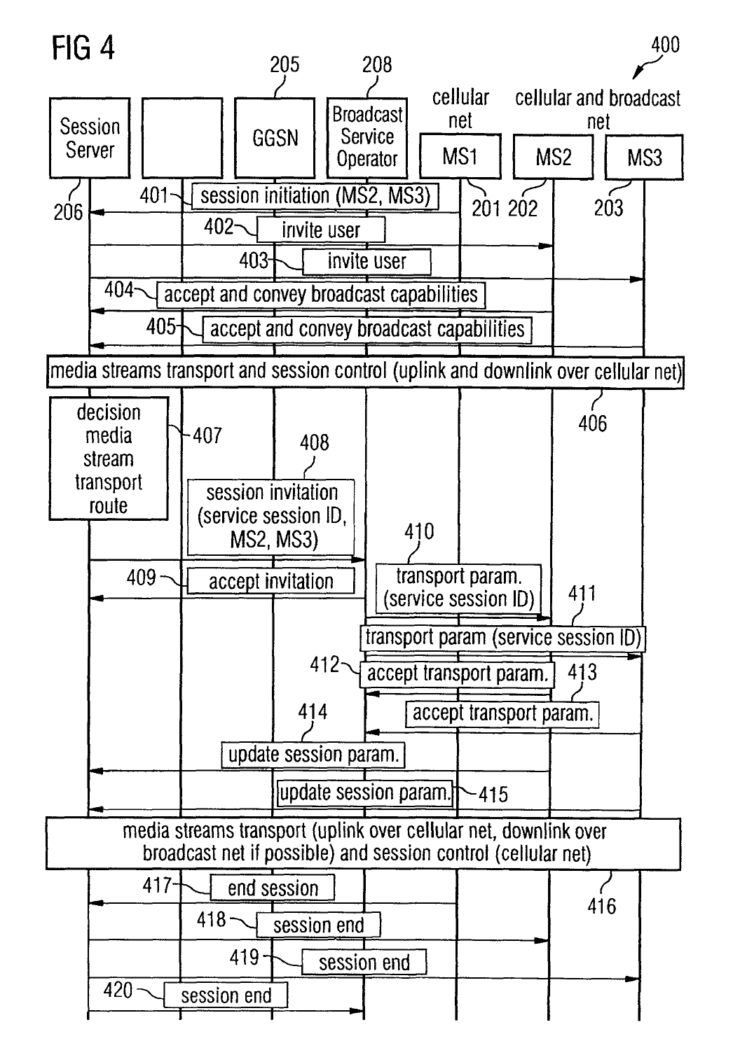

FIG. 4 uses a message flowchart 400 to show the setup and cleardown of a communication session by way of example using a Push-to-Talk communication session (particularly using the example of a Push-to-Talk over Cellular communication session, a PoC communication session).

The method processes for another communication session, such as IETF conferencing on the basis of the IETF Conferencing Framework, have the similar processes, possibly using other communication protocols which are usually used for the respective type of conference.

In a first step which is shown in FIG. 4, since the first mobile radio communication terminal 201 wishes to start a PoC communication session with the subscribers on the second mobile radio communication terminal 202 and on the third mobile radio communication terminal 203, this is accordingly conveyed to the PoC server 206 by means of IMS using the Session Initiation Protocol. To this end, the first mobile radio communication terminal 201 generates a first SIP-INVITE message 401 and sends it to the PoC server 206. The SIP-INVITE message 401 contains, as subscribers to be invited, the relevant identification statements, for example using the respective URI (Unique Resource Identifier), for the second mobile radio communication terminal 202 and for the third mobile radio communication terminal 203 as parameters (symbolized in FIG. 4 by the statements MS2, MS3).

When the first SIP-INVITE message 401 has been received, the PoC server 206 sets up an SIP communication link to the second mobile radio communication terminal 202 and to the third mobile radio communication terminal 203 by generating a second SIP-INVITE message 402 and transmitting it to the second mobile radio communication terminal 202, said message being used by the PoC server 206 to invite the second mobile radio communication terminal to the PoC communication session. The PoC server 206 invites the third mobile radio communication terminal 203 to the PoC communication session which is to be formed by forming a third SIP-INVITE message 403 and transmitting it to the third mobile radio communication terminal 203.

In a subsequent step, it is assumed that both the second mobile radio communication terminal 202 and the third mobile radio communication terminal or the two subscribers accept the invitation to the PoC communication session.

In addition, the mobile radio communication terminals 202, 203 transmit their relevant broadcast capabilities (for example the statement of their network interfaces or their current network connections) to the PoC server 206. This is done by means of one or more SIP broadcast capability messages, with the second mobile radio communication terminal 202 generating a first (or a plurality of first) SIP broadcast capability message 404 and transmitting it to the PoC server 206. In addition, the third mobile radio communication terminal 203 generates a second (or a plurality of second) SIP broadcast capability message 405 and sends it likewise to the PoC server 206. The SIP broadcast capability messages 404, 405 contain, as parameters, the statements describing the respective capabilities of the mobile radio communication terminals 202, 203 as regards receiving and/or processing broadcast messages.

When the two broadcast capability messages 404, 405 have been received, the PoC server 206 knows the respective broadcast capabilities of the two mobile radio communication terminals 202, 203.

A PoC communication link (PoC session) has now been set up between the PoC server 206 and the PoC clients of the mobile radio communication terminals 201, 202, 203, with a respective PoC client being provided in a respective mobile radio communication terminal 201, 202, 203, and this is symbolized in FIG. 4 by block 406 (media streams transport and session control (uplink and downlink over cellular net)). At this time, communication via the mobile radio communication network, in general, the cellular communication network, takes place both in the uplink communication direction and in the downlink communication direction.

The PoC server 206, in general the communication session server unit, to be more precise its decision unit, now makes a decision about what access technologies are to be used to circulate, that is to say transmit, the data within the context of the communication session using the Realtime Transport Protocol (RTP), for example whether the data are to be transmitted via a broadcast communication network and/or via a cellular communication network, for example via a cellular mobile radio communication network. It should be pointed out that not all the mobile radio communication terminals need to obtain their media data, that is to say have them transmitted to them, using the same access technology.

In this example, it is assumed that the media data are intended to be sent to the second mobile radio communication terminal 202 and the third mobile radio communication terminal 203 using the broadcast system, particularly the broadcast communication network. The first mobile radio communication terminal 201 is intended to receive the media data within the context of the PoC communication session by the “normal route” (peer-to-peer) using the respective channel in the cellular mobile radio communication network. This decision is made by the PoC server 206 using the decision unit, which is symbolized in FIG. 4 by block 407.

When the decision has been made, the PoC server 206 starts an SIP communication session with the broadcast service provider, in line with this exemplary embodiment with the Broadcast Service Operator unit 208. This involves the PoC server 206 transferring to the broadcast service provider, namely the Broadcast Service Operator unit 208, a list containing users (for example a list containing the SIP addresses of the users) which would be able and also would like to receive voice data, associated with the PoC communication session started and described above, via the broadcast technology which is provided by the broadcast service provider. This is done using a fourth SIP-INVITE message 408, the fourth SIP-INVITE message 408 containing, as parameters, the SIP addresses of the second mobile radio communication terminal 202 and of the third mobile radio communication terminal 203 and also the identification statement from the PoC communication session (Service Session ID) as parameters. The Service Session ID is provided for distinctly identifying the respective PoC communication session.

Upon receiving the fourth SIP-INVITE message 408, the broadcast service provider, for example the Broadcast Service Operator unit 208, checks whether sufficient free resources are available for the desired data transmission via the broadcast communication network, which is subsequently assumed without restricting general validity. If this is the case, the Broadcast Service Operator unit 208 accepts the invitation to the SIP communication session and communicates this to the PoC server 206 using a first SIP response message 409, which is generated by the Broadcast Service Operator unit 208 and is transmitted to the PoC server 206.

At least some of the processes described above are carried out using the IMS, with the IMS involving the SIP implemented therein being used.

If sufficient free resources are not available in the broadcast communication network for transmitting the voice data within the context of the communication session, or if no resources at all are available for transmitting the voice data within the context of the PoC communication session via the desired broadcast communication network, then the broadcast service provider, for example the Broadcast Service Operator unit 208, would reject the PoC communication session with the PoC server 206 with appropriate grounds and would use an appropriate rejection message (not shown) to communicate this to the PoC server 206. In this case, the voice data would continue to be transported conventionally and the method would be terminated at this point, which means that in this variant, there is no interaction (interworking) between the PoC communication network and the broadcast communication network.

If the transmission of the PoC communication session data for the second mobile radio communication terminal 202 and the third mobile radio communication terminal 203 by means of the broadcast communication network is accepted, however, then the broadcast service provider signals to the subscribers, that is to say to the users of the second mobile radio communication terminal 202 and of the third mobile radio communication terminal 203, the broadcast communication network parameters which are required for receiving the data sent via the broadcast communication network (particularly the requisite broadcast communication network parameters for receiving the voice data) for example using IMS. By way of example, this is done by virtue of the Broadcast Service Operator unit 208 generating a first SIP transport parameter message 410 and transmitting it to the second mobile radio communication terminal 202. In addition, the Broadcast Service Operator unit 208 generates a second SIP transport parameter message 411 and transmits it to the third mobile radio communication terminal 203.

Each of the two SIP transport parameter messages 410, 411 contains the Service Session ID as a parameter.

The SIP transport parameter messages 410,411 are appropriate SIP signaling messages, with the PoC Service Session ID identifying the PoC service session which is to be updated. The transport and content of the two SIP signaling messages 410, 411 from the broadcast service provider to the client units have the structure shown by way of example in Table 1. In order to accept the invitation to receive and process the PoC communication session data using the broadcast communication network and to communicate this to the Broadcast Service Operator unit 208, the second mobile radio communication terminal 202 generates a second SIP response message 412 and sends it to the Broadcast Service Operator unit 208.

In addition, the third mobile radio communication terminal 203 generates a third SIP response message 413 and transmits it likewise to the Broadcast Service Operator unit 208.

The structure of the respective response messages 412, 413 giving positive acknowledgement or rejection is likewise shown by way of example in the table below:

| Name | Source | Destination | Parameter |
|---|---|---|---|
| BCAST_CONFIG_REQ | Broadcast | Broadcast | Network |
| | Service | Client | parameter |

| | |
|---|---|
| Provider | IP |

multicast

Address

Frequency
Timeslot
Etc.

Service
parameter

Service
Session

ID

| BCAST_CONFIG_CONF | Broadcast | Broadcast |
|---|---|---|
| | Client | Service |
| | | Provider |
| BCAST_CONFIG_REJ | Broadcast | Broadcast |
| | Client | Service |

Provider

The configuration message, called the “BCAST_CONFIG_REQ” message, which is transmitted as SIP transport parameter message 410, 411 to the mobile radio communication terminals 202, 203 is used to notify the respective broadcast client, that is to say the relevant communication unit in the mobile radio communication terminal 202, 203, which communication unit allows the transmitted broadcast messages to be received and decoded, of all the necessary parameters for receiving the service using the broadcast communication network.

In addition, the message also contains information regarding the service which is to be received, however. In the example, it is the Service Session ID. The broadcast client, that is to say the relevant communication unit in the mobile radio communication terminal 202, 203, recognizes from the Service Session ID, the communication session or service for which it is configured. In addition, the broadcast client recognizes that the service, in other words the communication session or service, was already configured. It now has the opportunity to accept the broadcast configuration, which it could communicate to the Broadcast Service Operator unit 208 using the “BCAST_CONFIG_CONF” message, or to reject it, which it could communicate using the “BCAST_CONFIG_REJ” message, which messages are respectively generated by the respective mobile radio communication terminal 202,203 and transmitted to the Broadcast Service Operator unit 208.

However, it should be pointed out that the last two messages described are not required within the context of the message flow and can be omitted in alternative embodiments.

The PoC session clients of the second mobile radio communication terminal 202 and of the third mobile radio communication terminal 203 then update their respective PoC session parameters using a respective SIP-UPDATE message 414, 415, which is respectively generated by the respective mobile radio communication terminal 202, 203 and transmitted to the PoC server 206.

Instead of the SIP-UPDATE messages 414, 415 the PoC session clients can also be updated by virtue of the mobile radio communication terminals 202,203 generating a Re-INVITE message in line with SIP and transmitting it to the PoC server 206. The PoC server 206 then, that is to say upon receiving the SIP-UPDATE messages 414,415 or Re-INVITE messages 414,415, converts the transport addresses for the mobile radio communication terminals 202, 203. In this case, the PoC server 206 should recognize that the transport addresses for the second mobile radio communication terminal 202 and for the third mobile radio communication terminal 203 are identical, since they both receive the transport messages via the same broadcast server, of course, and therefore the voice messages are sent only once to the broadcast service provider. Following conversion of the transport addresses, the PoC session clients of the second mobile radio communication terminal 202 and of the third mobile radio communication terminal 203 receive the voice messages for the PoC communication session described above by means of the broadcast communication network. In other words, this means that the media data transport (the media data streams) is effected in the uplink direction using the cellular mobile radio communication network and in the downlink direction, that is to say in the data transmission direction from the communication network to the respective communication terminal, as far as possible using the respective broadcast communication network. The communication session control is affected using the cellular mobile radio communication network (symbolized in FIG. 4 by means of block 416).

The user of the first mobile radio communication terminal 201 wishes sometime to terminate the PoC communication session with the subscribers, that is to say the users of the second mobile radio communication terminal 202 and of the third mobile radio communication terminal 203.

The signaling to terminate the PoC session is effected by means of IMS using SIP messages to the PoC server 206. To this end, the first mobile radio communication terminal 201 generates and sends a SIP-BYE message 417 to the PoC server 206.

Upon receiving the SIP-BYE message 417, the PoC server 206 clears down the PoC communication session by generating respective SIP-BYE messages 418, 419 for each mobile radio communication terminal 202, 203. In addition, the PoC server 206 sends a first SIP-BYE message 418 to the second mobile radio communication terminal 202 and sends a second SIP-BYE message 419 to the third mobile radio communication terminal 203.

In addition, the PoC server 206 also clears down the PoC session with the Broadcast Service Operator unit 208, in general with the broadcast service provider. This is also done by virtue of the PoC server 206 generating a SIP-BYE message, namely a third SIP-BYE message 420 and sending it to the Broadcast Service Operator unit 208. In addition, upon receiving the third SIP-BYE message 420, the broadcast service provider, in line with this exemplary embodiment, the Broadcast Service Operator unit 208, ensures that the previously required resources are released again.

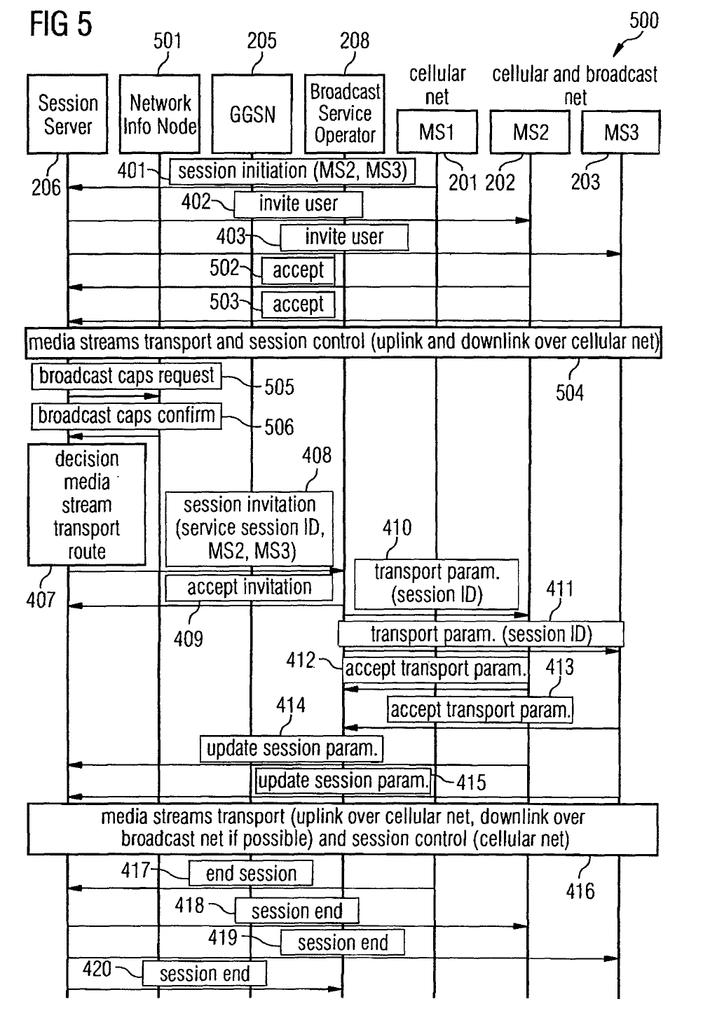

FIG. 5 shows another message flowchart 500 showing the message interchange in line with another exemplary embodiment of the invention.

The exemplary embodiment which is shown in the message flowchart 500 in FIG. 5 differs from the exemplary embodiment shown in FIG. 4 particularly in the procurement of the information about the broadcast capabilities of the PoC clients of the second mobile radio communication terminal 202 and of the third mobile radio communication terminal 203.

In the exemplary embodiment shown in FIG. 4, the information about the broadcast capabilities of the PoC clients of the second mobile radio communication terminal 202 and of the third mobile radio communication terminal 203 were transmitted to the PoC server 206 using the SIP transport parameter messages 404, 405.

In line with the message flowchart 500 in FIG. 5, the broadcast capabilities of the PoC clients of all the mobile radio communication terminals are, by contrast, managed centrally in a suitable network element, in line with this exemplary embodiment of the invention at a network information node 501, implemented as a server computer, with the PoC server 206 requesting the broadcast capabilities of the respective PoC clients which the PoC server 206 wishes to invite to the respective PoC communication session from the network information node 501, as will be explained in more detail below. Using the ascertained broadcast capabilities, the PoC server 206 then decides whether or not it wishes to attempt to transport the media data streams using the broadcast technology. In this connection, it should be noted that in line with 3GPP currently the RAT capabilities, that is to say the radio access technology capability parameters, only for GSM networks, for GPRS networks and for IP Multimedia Subsystem services (IMS) are managed centrally, that is to say in the HSS (Home Subscriber Server), in the HLR (Home Location Register), in the VLR (Visitor Location Register), in the S-CFCF (Serving Call Server Control Function), etc., but not the RAT capabilities, that is to say the radio access technology capability parameters of new transmission technologies, particularly of broadcast transmission technologies, such as DVB-T (Digital Video Broadcasting-Terrestrial), DVB-H (Digital Video Broadcasting-Handheld), MBMS (Multimedia Broadcast/Multicast Services), ISDB-T (Integrated Services Digital Broadcasting for Terrestrial), BCMCS (Broadcast/Multicast Services), etc. The text below describes how the RAT capability parameters of the mobile radio communication terminals 201, 202, 203 are managed centrally in the network element, that is to say at the network information node 501, and it is thus made possible to access the RAT capability parameters required for setting up/using mobile services quickly and comprehensively.

In this connection, it should be noted that although the RAT capability parameters of the receiver or the DVB-H network are known to the respective mobile terminal, that is to say to the respective mobile radio communication terminal, they are not known to the cellular communication network or to the network operator. Since service setup requires a large amount of interactivity (exchange of properties about hardware, protocols, software, access technologies, codecs, etc.) between a service provider and the service subscriber, it is advantageous, as described below, to use centrally managed network properties to speed up service setup considerably and to reduce the signaling complexity significantly.

The text below clearly describes central management of mobile radio RAT capability parameters at a central data management point, these being required in order to set up and operate services using a mobile communication terminal's network technologies managed at the data management point.

Central management of RAT capability parameters allows every entity which is involved in and authorized for service setup to access properties of subscribers, that is to say of their mobile radio communication terminals, quickly. The data management point, in line with this exemplary embodiment of the invention the network information node 501, is accessed using a distinct private identification number or using a distinct public identification number, such as a public/private user identity and a device-specific identification number.

The example below illustrates the benefit of using a network information node 501 of this kind for central management of RAT capability parameters.
1. A subscriber wishes to participate in a communication service, such as a video conference or a PoC communication session as described above.
2. The service provider and the subscriber set up a multimedia communication session using the Session Initiation Protocol (SIP) between the subscribers and the relevant application server (AS) or the relevant media resource function controller (MRFC) of the IP Multimedia Subsystem (IMS). At the same time, the subscriber or the mobile radio communication terminal transmits parameters regarding the desired quality of the communication session.
3. The service provider inquires at the data management point for mobile radio RAT capability parameters about the latter's properties using a distinct identification parameter, for example using the private user ID and/or IMSI.
4. The service provider uses the RAT capability parameters to decide that the communication service is to be transmitted using a broadcast transmission technology, for example using DVB-H, because this is the only way in which the desired quality can be achieved.
5. The service provider contacts the broadcast communication network provider, as described in connection with the second exemplary embodiment of the invention, and sets up the service thereto.
6. The subscriber or the mobile radio communication terminal is notified about the reception parameters (for example the RAT DVB-H, the IP address, the port statement, the information about the communication protocol to be used and the information about the media types used) by means of the Session Description Protocol (SDP), and accepts. The signaling is effected using the cellular mobile radio communication network, alternatively using the broadcast communication network.
7. The subscriber or the mobile radio communication terminal receives the video data stream for the conference or the PoC data stream for the PoC communication session using the broadcast communication network. As can be seen from the procedure described above, only very low signaling complexity is required in order to request the necessary information from the subscriber mobile radio communication terminal, since the network-specific information from the data management point (e.g. the network information node) can be retrieved at any time and is available in up-to-date form and in full. This makes a reduction particularly on the air communication interface, which can provide only limited resources. In addition, it is not first necessary to set up a dedicated communication session within the context of the procedure described above which is then replaced by a more powerful communication session.

The data management point can be implemented at various locations, for example within the IP-based Multimedia Subsystem (IMS). Positioning the network information node 501 within the IMS has the advantage, for example, that other data management points, such as Non-GPRS-Network-Access-Mode-Data-Storage, (Circuit-Switched) GPRS-Network-Access-Mode-Storage and IP-Multimedia-Service-Data-Storage (for IMS services), are likewise connected to the IMS or part of the IMS and can therefore very easily likewise request the RAT capability parameters.

| Parameter | | | | Example Value | Timestamp |
|---|---|---|---|---|---|
| Private User Id | | | | max@xyz.com | |
| (NAI) | | | | | |
| Public User Id | | | | sip:max@xyz.com | |
| (SIP URI □rt el | | | | | |
| URL) | | | | | |
| List of authorized | | | | 26201, 26202, | |
| visited network Id | | | | 22201, . . . | |
| IMSI | | | | 262020123456789 | |
| IMEI | | | | 00-4999-00-282340-8 | |
| | RAT | | | DVB-H | |
| | | Status | | Connected | 10:35:24 |
| | | Provider | | 26255 | |
| | | Gateway Address | | 222.20.4.12 | |
| | | Network Provider | | | |
| | | Location/Position | | 262-55-0815 | 11:12:00 |
| | | . . . | | | |
| | | Reception Parameter | | | |
| | | Session | | Session 1 | 12:12:21 |
| | | | PDP | IP | |
| | | | Type | | |
| | | | PDP | 11.34.87.33 | |
| | | | Address | | |
| | | Session | | Session 2 | 12:14:01 |
| | | | PDP | PPP | |
| | | | Type | | |
| | | | PDP | 17.4.240.8 | |
| | | | Address | | |
| | RAT | | | DMB | |
| | | Status | | Unconnected | 10:35:24 |
| | | Provider | | 26233 | |
| | | Gateway Address | | 49.99.4.1 | |
| | | Network Provider | | | |
| | | Location/Position | | None | |
| | | . . . | | | |
| | | Reception Parameter | | None | |
| | | Session | | None | |
| | | | PDP | None | |
| | | | Type | | |
| | | | PDP | None | |
| | | | Address | | |
| IMSI | | | | 2620201234567891 | |
| IMEI | | | | 35-3910-00-298554-0 | 01:56:34 |
| | RAT | | | DAB | |
| | | Status | | Unconnected | 01:56:34 |
| | | Provider | | 26233 | |
| | | Gateway Address | | 223.23.1.1 | |
| | | Network Provider | | | |
| | | Location/Position | | None | |
| | | . . . | | | |
| | | Reception Parameter | | None | |
| | | Session | | None | |
| | | | PDP | None | |
| | | | Type | | |
| | | | PDP | None | |
| | | | Address | | |

The data management point and hence the network information node 501 based on this exemplary embodiment of the invention can contain data for identifying the subscriber and the mobile terminal, for example the mobile radio communication terminals 201, 202, 203, generally valid data, network-specific data, permanent and temporary data. The mobile RAT capability parameters need to be accessible using a distinct identification number. The data can be split into a general part, a device-dependent part (possibly a plurality of terminals belonging to the subscriber) and a network-technology-specific part (a plurality of RAT modules) which contains information regarding the individual transmission technologies, providers, services, addresses, etc. Within the network-technology-specific part, the data can be managed in a manner structured according to transmission technologies. Temporarily valid data can be timestamped to identify the time of the last update. An exemplary data record, without restricting general validity, is shown in the table below.

The table described above shows an example of a RAT capability parameter for the provider XYZ. The data managed for the subscriber Max are to be understood as follows.

In the general part, data relating to people are stored using rights, which have no direct link to the RAT capability parameters. Examples of these are the Private User ID (in this case Max@XYZ.com) for distinctly identifying Max, the Public User ID (SIP:Max@XYZ.com) or the list of authorized visited networks, which identify the roaming communication networks, in line with the exemplary embodiment these are the communication networks which are identified by means of the identification statements 26201, 26202, 22201.

The device-specific part of the table shown above manages a list of the respective mobile radio communication terminals. In the example described above, without restricting general validity, these are two mobile radio communication terminals, namely a first mobile radio communication terminal which is identified by means of the IMSI 262020123456789 and with the IMEI 00-4999-00-282340-8 and also a second mobile radio communication terminal, identified by means of the IMSI 2620201234567891 and the IMEI 35-3910-00-298554-0.

The device-specific part manages a list containing RAT modules belonging to the respective mobile radio communication terminal, for example of a DVB-H reception module, of a DMB reception module, of a DAB reception module etc. This part contains information relating to the status of the respective RAT module relating to the provider, the provider gateway address, the location/position (for example in a statement for a mobile radio cell which currently contains the mobile radio communication terminal) and other information, such as RAT-specific reception parameters. In the present example, it is assumed that the first mobile radio communication terminal shown in the list has a DVB-H reception module whose status is assumed to be “Connected”, whose provider is identified by means of the identification parameter 26255, whose gateway address is identified by means of the IP address 220.04.12 and whose location/position is assumed to be a position within the mobile radio cell, identified by the parameter 262-55-0815. In addition, two sessions are active whose parameters are likewise recorded in the table described above, a first session being of the PDP type IP (Internet Protocol) and a second session being of the PDP type PPP (Point-to-Point Protocol).

It is also assumed that the first mobile radio communication terminal shown in the list has a RAT reception module which has the status “Unconnected” and is registered with the provider 26233, the gateway address of the provider being 49.99.4.1.

The second mobile radio communication terminal shown in the list has a DAB reception module, it being assumed that this currently has the status “Unconnected”. The DAB reception module is registered with the provider 26233, the gateway address of the provider being 223.23.1.1.

In line with this embodiment of the invention, it is assumed that some parameters have been provided with a timestamp. The respective timestamps identify temporary parameters. A timestamp indicates when the respective parameter was last updated or altered.

It should be pointed out that the RAT capability parameter table described above is just one example.

In other embodiments of the invention, other parameters may be provided or some parameters may be omitted.

The table described above is intended merely to serve to explain the principle of the RAT capability parameter table at a data management point.

Within the context of updating the parameters managed by the data management point, the respective mobile radio communication terminal and the data management point interchange information using messages via the cellular mobile radio communication network (for example GSM, GPRS, UMTS). The messages are filled with the available contents and sent automatically by the mobile radio communication terminal. The nature of the messages or the respectively used communication protocol which is used for transmitting the message can be selected arbitrarily, for example the message contents can be described using XML (Extensible Markup Language). The messages can be transported using IMS.

The text below presents exemplary alternatives for updating the data management point, for example the network information node 501:
a) Event-controlled:
   Event-controlled sending of the messages has the advantage that an update is started only when an event occurs.
   Examples of valid events are:
      The mobile radio communication terminal changing to another mobile radio cell (Handover) in the case of GSM, UMTS, DVB-H, etc.;
      The mobile radio communication terminal changing to another PLMN (Public Land Mobile Network) (Roaming);
      The mobile radio communication terminal being turned on/off;
      Signal reception strength is insufficient over a prescribable relatively long period of time or is sufficient again;
      The mobile radio communication terminal participating in a service;
      A mobile radio communication terminal being equipped/extended with a further transmission technology, for example by adding a further broadcast reception module;
      The mobile radio communication terminal being changed;
      A further mobile radio communication terminal being started up.
b) Periodic:
   The data management point requests the required data or the validity thereof periodically, for example every 60 minutes (or at any other time interval). This may be desirable if the mobile radio communication terminal has been moved to an area with insufficient reception signal strength, for example, and has no longer been able to send messages. In this case, the data management point is able to identify this and to mark or erase appropriate temporary entries.
c) By another service or enabler:
   The data management point can consult or request already existing services for appropriate information. It is desirable to reuse existing services in order to update the information managed at the data management point.
      By way of example, the practice described above has the following advantages:
Reduced signaling complexity for service setup. This saves required bandwidth particularly on the air interface.
Service setup is immediately possible on the basis of the subscriber's prescribable requirements (for example improved quality) and according to terminal capabilities.
Faster service setup is possible than with conventional communication systems.
The unidirectional broadcast transmission technologies of the next generation require new or additional signaling parameters and protocol extensions. Managing these RAT capability parameters at one location, namely the network information node, generally the data management point, helps the service providers to contact a subscriber in dedicated fashion.
The structure of the RAT capabilities table allows simultaneous management of a plurality of terminals and their RAT capability parameters.

The message flow for setting up the communication session as shown in FIG. 5 is such that first of all the first mobile radio communication terminal 201 transmits an SIP session initiation message 401 to the PoC server 206 and the latter invites the second mobile radio communication terminal 202 and also the third mobile radio communication terminal 203 to the communication session using SIP-INVITE messages 402 and 403.

The second mobile radio communication terminal 202 and the third mobile radio communication terminal 203 respectively generate an SIP acceptance message 502 or 503 which they use to accept the invitation to the PoC session. In line with this exemplary embodiment, unlike the exemplary embodiment of the invention shown in FIG. 4, the SIP acceptance messages 502 and 503 which the mobile radio communication terminals 202, 203 respectively transmit to the PoC server 206 do not contain the broadcast capability parameters of the mobile radio communication terminals 202, 203, since these are stored and managed centrally at the network information node 501, of course.

In line with the exemplary embodiment shown in FIG. 5, a PoC session symbolized by means of block 504 has therefore now been set up, with the media data streams and transport thereof and session supervision, i.e. session control, taking place in the uplink direction and in the downlink direction using the cellular mobile radio communication network.

Next, the PoC server 206 uses an SIP broadcast capability parameter request message 505, which the PoC server 206 generates and transmits to the network information node 501 and which is used to ascertain the broadcast capability parameters of the second mobile radio communication terminal 202 and of the third mobile radio communication terminal 203, generally the subscribers in the PoC session. Upon receipt of the SIP request message 505, the network information node 501 ascertains the parameters, i.e. the broadcast capability parameters of the second mobile radio communication terminal 202 and of the third mobile radio communication terminal 203 and transmits them to the PoC server 206 in an SIP-Confirm message 506 generated by the network information node 501.

This means that the broadcast capability parameters of the mobile radio communication terminals 202, 203 are known and available in the PoC server 206.

The rest of the message flow in the exemplary embodiment shown in FIG. 5 corresponds to the first exemplary embodiment shown in FIG. 4, which is why a repeat explanation is not given.

The information about the broadcast capabilities is procured, by way of example, after a “regular” session has been set up, for example after an SIP session has been set up, as described above, since only during session setup is it ascertained what clients wish to participate in the session.

However, it should be pointed out that in one alternative embodiment the session server, in line with the exemplary embodiment of the invention the PoC server 206, can implement the broadcast capabilities of the clients before the SIP-INVITE messages 402, 403 are transmitted to the mobile radio communication terminals 202, 203 of the clients.

It should also be pointed out that in other embodiments of the invention it is possible to include functions which have general demands on mobile radio data transmission, such as security functions, service and content protection functions, billing functions etc., but these have no influence on the fundamental principle described above.

What is claimed is:

1. A communication session server, comprising:
a communication session setup unit setting up a communication session with a plurality of communication terminals;
a communication session control unit controlling the communication session which has been set up;
a receiver receiving at least one broadcast capability parameter from at least one communication terminal participating in the communication session, the at least one broadcast capability parameter specifying whether the communication terminal can receive data using a broadcast communication network;
a decision maker deciding whether data within a context of the communication session are to be transmitted to the communication terminal using a broadcast communication network; and
a broadcast request message generation unit generating a broadcast request message for a broadcast server to transmit data within the context of the communication session to the at least one communication terminal using a broadcast communication network.

2. The communication session server as claimed in claim 1, further comprising:
a checking unit checking whether the communication terminal can receive data using a broadcast communication network based on the at least one received broadcast capability parameter,
wherein the decision maker decides to transmit the data within the context of the communication session using the broadcast communication network only if the communication terminal can receive data using a broadcast communication network based on the checking result from the checking unit.

3. The communication session server as claimed in claim 1, wherein the communication session setup unit communicates based on a communication session setup protocol.

4. The communication session server as claimed in claim 3, wherein the communication session setup unit communicates based on the Session Initiation Protocol.

5. The communication session server as claimed in claim 1, wherein the broadcast request message generation unit generates the broadcast request message based on a communication session setup protocol.

6. The communication session server as claimed in claim 5, wherein the broadcast request message generation unit generates the broadcast request message based on the Session Initiation Protocol.

7. The communication session server as claimed in claim 1, providing a half-duplex communication session.

8. The communication session server as claimed in claim 7, providing a Push-to-Talk communication session.

9. The communication session server as claimed in claim 8, providing a Push-to-Talk-over-Cellular communication session.

10. The communication session server as claimed in claim 1, providing an Internet-based communication session.

11. A communication terminal, comprising:
a communication session client implementing a communication session with at least one other communication terminal using a communication session server; and
a message generation unit generating at least one broadcast capability message, the message generation unit adding at least one broadcast capability parameter to the broadcast capability message, the at least one broadcast capability parameter specifying whether the communication terminal can receive data using a broadcast communication network.

12. The communication terminal as claimed in claim 11, wherein the communication session client communicates based on the Session Initiation Protocol.

13. The communication terminal as claimed in claim 11, providing a half-duplex communication session.

14. The communication terminal as claimed in claim 13, providing a Push-to-Talk communication session.

15. The communication terminal as claimed in claim 14, providing a Push-to-Talk-over-Cellular communication session.

16. The communication terminal as claimed in claim 11, providing an Internet-based communication session.

17. A network unit, comprising:
a receiver receiving at least one broadcast capability parameter from at least one communication terminal, the at least one broadcast capability parameter specifying whether the communication terminal can receive data using a broadcast communication network;
a memory storing the at least one received broadcast capability parameter; and
a transmitter sending the at least one broadcast capability parameter to a communication session server.

18. The network unit as claimed in claim 17, further comprising a communication session client implementing a communication session with the communication session server.

19. The network unit as claimed in claim 18, wherein the communication session client communicates based on the Session Initiation Protocol.

20. A method of controlling a communication session with a plurality of communication terminals, comprising:
making a decision, using at least one received broadcast capability parameter from at least one communication terminal participating in the communication session, the at least one broadcast capability parameter specifying whether the communication terminal can receive data using a broadcast communication network, regarding whether data within a context of the communication session are to be transmitted to the communication terminal using a broadcast communication network, and
if data within the context of the communication session are to be transmitted to the communication terminal using a broadcast communication network, then generating a broadcast request message for a broadcast server to transmit data within the context of the communication session to the at least one communication terminal using a broadcast communication network.

21. A method of setting up a communication session, comprising a communication session client of a communication terminal setting up a communication session with at least one other communication terminal using a communication session server, with at least one broadcast capability parameter, which specifies whether the communication terminal can receive data using a broadcast communication network, being sent to the communication session server.

22. A computer program element which, when executed by a processor, carries out a method for controlling a communication session with a plurality of communication terminals comprising:
making a decision, using at least one received broadcast capability parameter from at least one communication terminal participating in the communication session, the at least one broadcast capability parameter specifying whether the communication terminal can receive data using a broadcast communication network, regarding whether data within a context of the communication session are to be transmitted to the communication terminal using a broadcast communication network; and
if data within the context of the communication session are to be transmitted to the communication terminal using a broadcast communication network, then generating a broadcast request message for a broadcast server to transmit data within the context of the communication session to the at least one communication terminal using a broadcast communication network.

23. A computer program element which, when executed by a processor, carries out a method for setting up a communication session comprising a communication session client of a communication terminal setting up a communication session with at least one other communication terminal using a communication session server, with at least one broadcast capability parameter, which specifies whether the communication terminal can receive data using a broadcast communication network, being sent to the communication session server.

24. A communication session server, comprising:
a communication session setup means for setting up a communication session with a plurality of communication terminals;
a communication session control means for controlling the communication session which has been set up;
a receiving means for receiving at least one broadcast capability parameter from at least one communication terminal participating in the communication session, the at least one broadcast capability parameter specifying whether the communication terminal can receive data using a broadcast communication network;
a decision making means for deciding whether data within a context of the communication session are to be transmitted to the communication terminal using a broadcast communication network; and
a broadcast request message generation means for generating a broadcast request message for a broadcast server to transmit data within the context of the communication session to the at least one communication terminal using a broadcast communication network.

25. A communication terminal, comprising:
a communication session client means for implementing a communication session with at least one other communication terminal using a communication session serving means; and
a message generating means for generating at least one broadcast capability message, the message generating means adding at least one broadcast capability parameter to the broadcast capability message, the at least one broadcast capability parameter specifying whether the communication terminal can receive data using a broadcast communication network.

26. A network unit, comprising:
a receiving means for receiving at least one broadcast capability parameter from at least one communication terminal, the at least one broadcast capability parameter specifying whether the communication terminal can receive data using a broadcast communication network;
a memory means for storing the at least one received broadcast capability parameter; and
a transmitting means for sending the at least one broadcast capability parameter to a communication session serving means.
